(19) United States
(12) Patent Application Publication
(10) Pub. No.: US 2018/0113063 A1
(43) Pub. Date: Apr. 26, 2018

(54) FLOW CYTOMETER STERILE FLUID DISPENSING SYSTEMS AND METHODS FOR USING THE SAME

(71) Applicant: Becton, Dickinson and Company, Franklin Lakes, NJ (US)

(72) Inventors: Veronica Lauren Kersten, Bellevue, WA (US); Timothy Wayne Petersen, Seattle, WA (US); Valdis Janis Riekstins, Woodinville, WA (US)

(21) Appl. No.: 15/571,251

(22) PCT Filed: Aug. 24, 2016
(86) PCT No.: PCT/US16/48433

§ 371 Date: Nov. 1, 2017

Related U.S. Application Data
(60) Provisional application No. 62/214,536, filed on Sep. 4, 2015.

(51) Int. Cl. G01N 15/14; B01L 3/00

(52) U.S. Cl. CPC G01N 15/1404; B01L 3/502; B01L 2200/06; B01L 2200/026; B01L 2200/16; G01N 2015/1409

(57) ABSTRACT

Aspects of the present disclosure include systems for dispensing a fluid, such as a sheath fluid, into a sample flow system of a flow cytometer. Systems according to certain embodiments include a housing and a pliant fluid dispensing container structure having a first pliant container and a second pliant container, where the second pliant container is configured to apply an amount of pressure to a fluid reservoir of the first pliant container sufficient to convey fluid from the fluid reservoir. Pliant fluid dispensing container structures and methods for using the subject systems to dispense a fluid, such as a sheath fluid to a sample flow system of a flow cytometer, are also described. Kits, having one or more of the pliant fluid dispensing container structures and sterile connector for coupling to a sample flow system are also provided.

### CROSS-REFERENCE TO RELATED APPLICATIONS

This application claims priority to U.S. Provisional Patent Application Ser. No. 62/214,536 filed Sep. 4, 2015, the disclosure of which application is incorporated herein by reference.

### INTRODUCTION

Flow cytometers are used for analyzing and sorting particles in a fluid sample, such as cells of a blood sample or particles of interest in any other type of biological or chemical sample. A flow cytometer typically includes a sample reservoir for receiving a fluid sample, and a sheath reservoir containing a sheath fluid. The flow cytometer transports the particles in the fluid sample as a cell stream to a flow cell, while also directing the sheath fluid to the flow cell. Within the flow cell, a liquid sheath is formed around the cell stream to impart a substantially uniform velocity on the cell stream. The flow stream exits the flow cell via a nozzle with a nozzle diameter that is appropriate for the fluidics system and sort rate desired.

Sheath fluid is a buffered solution that forms an annular flow coaxial with the sample fluid, creating a hydrodynamically focused flow of particle-containing sample fluid in the center of the fluid stream, surrounded by particle-free sheath fluid. In general, the ratio of sheath fluid to sample fluid is high where the sample fluid is only a small fraction of the total fluid passing through the flow cell.

In some flow cytometers, the sheath fluid is provided to the flow cell by a pressure driven fluidics system where the sample fluid and sheath fluid are passed through the flow cell under pressure greater than ambient pressure. Changes in the flow rate through the flow cell are achieved by varying the pressure in the sheath fluid reservoir and the ratio of sample fluid to sheath fluid in hydrodynamic flow is determined by the exerted pressure in the sample source and sheath fluid reservoir, as well as by the resistance of the fluidic system supplying the sample and sheath fluid. Flow cytometers can also use a vacuum-driven fluidics system where a vacuum pump draws vacuum downstream from the flow cell and the sample and sheath fluids remain at ambient pressure. To change the rate through the flow cell, vacuum is drawn by the vacuum pump and the ratio of sample fluid to sheath fluid that flows through the flow cell is determined by the ratio of the resistance exerted by the paths of the sample fluid and sheath fluid systems. Fluidic systems providing a hydrodynamically focused flow of particle-containing sample fluid in the center of a particle-free sheath fluid stream often utilize pressurizable tubings, connections and seals that are required to withstand wide ranges of pressure levels, in particular high and low pressures.

### SUMMARY

Aspects of the present disclosure include systems for dispensing a fluid, such as a sheath fluid, into a sample flow system of a flow cytometer. Systems according to certain embodiments include a housing and a pliant fluid dispensing container structure having a first pliant container and a second pliant container, where the first pliant container includes a fluid reservoir and a conduit that has a proximal end and a distal end where the proximal end is fluidically coupled to the fluid reservoir and the distal end is configured for coupling the conduit to a sample flow system of a flow cytometer; and the second pliant container includes a gas reservoir and a port in gaseous communication with the gas reservoir where the second pliant container is positioned in the housing with the first pliant container and is configured to apply pressure to the fluid reservoir of the first pliant container to convey fluid from the distal end of the conduit into the sample flow system of the flow cytometer.

Fluid is conveyed from the fluid reservoir of the first pliant container by pressure applied by the second pliant container. To apply pressure to the reservoir of the first pliant container, the second pliant container is filled with a gas and the second pliant container exerts pressure (e.g., by expansion of the gas reservoir) onto the first pliant container sufficient convey fluid from the fluid reservoir. In some instances, the second pliant container applies a pressure to the first pliant container that is sufficient to convey fluid at a rate of 100 μL/sec or more. The applied pressure may be continuous or in discrete intervals and the pressure may be applied at a single position on the fluid reservoir of the first pliant container or may be applied at a plurality of different positions. In certain embodiments, the first pliant container is positioned at least within and stably associated with the second pliant container, such as where the first pliant container is wholly positioned within the second pliant container.

In some embodiments, the first pliant container includes a fluid reservoir having one or more ports, which may be irreversibly sealed after the first pliant container is filled with fluid, such as a sheath fluid. The conduit may be irreversibly affixed to the fluid reservoir or may be integrated directly into the fluid reservoir. The distal end of the conduit includes a fitting that is configured to couple to a connector or directly to a sample flow system of a flow cytometer. In certain embodiments, the connector may be a sterile connector having a Luer-lock fitting.

One or more of the first pliant container and second pliant container are affixed to an interior wall of the housing. The housing may include a fastener, such as a hook, an adhesive or hook-and-loop type fastener. In certain instances, the first pliant container and second pliant container include a hole for hanging onto a hook on an interior wall of the housing.

Aspects of the present disclosure also include methods for dispensing a fluid, such as a sheath fluid into a sample flow system of a flow cytometer. In practicing the subject methods according to certain embodiments, a gas is inputted into a second pliant container such that the second pliant container applies a pressure to a fluid-containing reservoir of a first pliant container where the exerted pressure is sufficient to convey fluid from the fluid reservoir, such as into a sample flow system of a flow cytometer. Inputting of the gas into the gas reservoir of the second container may exert a continuous pressure onto the first pliant container or the pressure may be applied in discrete intervals. The applied pressure, in certain embodiments, is sufficient to convey fluid from the distal end of the first pliant container conduit at a flow rate of 100 μL/sec or more.

The distal end of the conduit of the first pliant container may be coupled to a sample flow system of a flow cytometer sample by a sterile connecter, such as a connector having a Luer-lok fitting. In some embodiments, the conduit distal end is sealed until being coupled to the sterile connector. In certain embodiments, methods include replacing the first pliant container with a third pliant container. To replace the first pliant container with a third pliant container, the distal end of the first pliant container conduit is disconnected from the connector or from the sample flow system of the flow cytometer when directly coupled. In certain embodiments, the sample flow system of the flow cytometer becomes sealed upon disconnecting from the first pliant container. Without cleaning or washing of the flow cytometer sample flow system, the third pliant container may be connected to the sample flow system. Where the first pliant container is wholly positioned within the second pliant container, methods may include inserting the third pliant container into the second pliant container. In other embodiments, the pliant fluid dispensing container structure having the first and second pliant containers is disconnected and discarded and a second pliant fluid dispensing container structure having a third pliant container that is wholly positioned within a fourth pliant container is connected to the sample flow system. In these embodiments, the fourth pliant container includes a gas reservoir and a port in gaseous communication with the gas reservoir and is configured to apply pressure to the fluid reservoir of the third pliant container sufficient to convey fluid from the distal end of the third pliant container conduit into the sample flow system of the flow cytometer.

In practicing the subject methods, the pliant containers may be further affixed to the interior wall of a housing. In some embodiments, methods include hanging one or more of the pliant containers onto a hook on the interior wall. In other embodiments, the pliant containers may be affixed to the interior wall of the housing by an adhesive or coupled by a hook-and-loop fastener.

Kits are also provided by the present disclosure. In some embodiments, kits include a first pliant container, a second pliant container and a sterile connector configured to couple a conduit of the first pliant container to a flow cytometer sample flow system. In certain instances, the first pliant container has an amount of fluid present in the fluid reservoir, such as a sheath fluid. In certain embodiments, the first pliant container is positioned at least within and stably associated with the second pliant container, such as where the first pliant container is wholly positioned within the second pliant container. Kits may also include a fastener for affixing one or more of the pliant containers to a housing.

### BRIEF DESCRIPTION OF THE FIGURES

FIG. 1 depicts a first pliant container for dispensing a fluid (e.g., a sheath fluid) according to certain embodiments.

FIG. 2 depicts a pliant fluid dispensing container structure having a first pliant container and a second pliant container according to certain embodiments.

FIG. 3 depicts a system for providing a fluid having a pliant fluid dispensing container structure according to certain embodiments.

### DETAILED DESCRIPTION

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As summarized above, the present disclosure provides systems and methods for dispensing a fluid, such as a sheath fluid, into a sample flow system of a flow cytometer. In further describing embodiments of the disclosure, a fluid dispensing container structure having a first pliant container having a fluid reservoir and a conduit for coupling to a sample flow system of a flow cytometer and second pliant container having a gas reservoir and an inlet conduit for inputting a gas from a gas source are first described in greater detail. Next, systems for dispensing a fluid, such as a sheath fluid into a sample flow system of a flow cytometer are described. Methods and kits for dispensing a fluid with the subject systems are also reviewed in greater detail.

### Pliant Fluid Dispensing Container Structures

As summarized above, aspects of the present disclosure include a fluid dispensing container structure configured to convey a fluid from a fluid reservoir, such as a sheath fluid, to a sample flow system of a flow cytometer. Fluid dispensing container structures according to certain embodiments include a first pliant container that is positioned at least partially within and stably associated with a second pliant container. In embodiments, the first pliant container includes a fluid reservoir and a conduit having a proximal end coupled to the fluid reservoir and a distal end that is configured for coupling to a sample flow system of a flow cytometer. The second pliant container includes a gas reservoir and an inlet conduit in gaseous communication with the gas reservoir. The term “pliant” is used herein in its conventional sense to mean that the container is capable of being bent or flexed from its original shape without any structural damage, such as tearing, cracking, perforating, etc. As described in greater detail below, the subject pliant containers may be flexible, such as where the container reverts back to its original shape after an applied deforming stimulus (pressure from squeezing, pressing, etc.). In other embodiments, the subject pliant containers are compliant, where the shape of the container changes in response to the applied deforming stimulus without structural damage but retains the deformed shape. In embodiments, the containers may be flexed or deformed from their original shape, while still maintaining sterility of a composition inside of the container, such as by maintaining a seal against contact from the surrounding environment.

In some embodiments, only a portion of the container is pliant. In some instances, only the reservoir component of the container is pliant, such as where 25% or more of the reservoir component of the container is pliant, such as 50% or more, such as 75% or more and including 90% or more of the reservoir component of the container is pliant. In other instances, the entire (i.e., 100%) reservoir component of the container is pliant. In certain embodiments, the container may be a rigid (i.e., non-pliant) container that includes one or more pliant regions, such as 2 or more pliant regions, such as 3 or more pliant regions, such as 5 or more pliant regions and including 10 or more pliant regions. Where the container is a rigid container having one or more pliant regions, the total collective surface area of pliant regions on the container may be 5% or greater of the total surface area of the container, such as 10% or greater, such as 25% or greater, such as 50% or greater, such as 75% or greater and including 90% or greater. Each pliant region may be any convenient shape, such as in the shape of a circle, oval, half-circle, crescent-shaped, star-shaped, square, triangle, rhomboid, pentagon, hexagon, heptagon, octagon, rectangle or some other convenient shape. Depending on the size of the container, each pliant region may be 1 cm² or greater, such as 2 cm² or greater, such as 3 cm² or greater, such as 5 cm² or greater, such as 10 cm² or greater, such as 15 cm² or greater and including 25 cm² or greater.

In other instances, both the reservoir and conduits in communication (fluid or gaseous) with the reservoir are pliant. In certain embodiments, the entire (100%) container (i.e., reservoir and conduits) is pliant.

In embodiments, the subject fluid dispensing container structures include a first pliant container and a second pliant container. The first pliant container includes a fluid reservoir and a conduit in fluid communication with the fluid reservoir that is configured to convey fluid from the reservoir to a sample flow system of a flow cytometer. The fluid reservoir is configured to contain a fluid, such as for example a sheath fluid.

The term “sheath fluid” is used herein in its conventional sense to refer to fluid conveyed through a conduit (e.g., in a flow cytometer) that is used to form an annular flow coaxial with a sample-containing fluid creating a hydrodynamically focused flow of particle-containing sample fluid in the center of the sheath fluid stream. Sheath fluids of interest may be any convenient buffered composition, such as for use in a flow cytometer and may include one or more salts, including but not limited to potassium phosphate, potassium chloride, sodium phosphate, sodium chloride, preservatives as well as chelating agents, such as disodium ethylenediaminetetraacetic acid (EDTA).

In certain embodiments, pliant fluid dispensing container structures of interest include a fluid (e.g., sheath fluid) positioned within the reservoir of the first pliant container. Depending on the volume of the fluid reservoir (as described below), the amount of fluid present in the first pliant container may be 10 mL or more, such as 25 mL or more, such as 50 mL or more, such as 100 mL or more, such as 250 mL or more, such as 500 mL or more, such as 750 mL or more, such as 1 L or more, such as 5 L or more and including 10 L or more, where in some instances the volume is 7.5 L or less, such as 5 L or less.

The interior volume of the first pliant container may be sterile. By “sterile” is meant free from live bacteria or other microorganisms, i.e., free from living germs or microorganisms; aseptic. As such, the first pliant container may be sealed to maintain sterility. For example, the first pliant container may be closed to the surrounding environment to prevent undesired contact between the interior volume of the first pliant container and the surrounding environment. In embodiments where a fluid is pre-filled into the fluid reservoir of the first pliant container, the fluid may be sterilized before or after inputting into the first pliant container, such as by gamma radiation. In these embodiments, the inlet conduit used to input the fluid may be subsequently sealed, such as by press-sealing, crimping, heat-sealing or by closing the lumen of the inlet conduit with an adhesive.

When the fluid reservoir is filled with fluid (i.e., maximum fluidic capacity), the fluid reservoir of the first pliant container may have a volume that varies, ranging from 50 cm³ to 25000 cm³, such as from 75 cm³ to 20000 cm³, such as from 100 cm³ to 15000 cm³, such as from 250 cm³ to 10000 cm³, such as from 500 cm³ to 7500 cm³, such as from 750 cm³ to 6000 cm³ and including from 1000 cm³ to 5000 cm³. As described in greater detail below, to convey fluid from the reservoir out through the outlet conduit, pressure is applied to the fluid reservoir of the first pliant container. In some embodiments, the applied pressure is sufficient to reduce the volume of the fluid reservoir by 10% or more, such as by 15% or more, such as by 25% or more, such as by 50% or more, such as by 60% or more, such as by 75% or more, such as by 90% or more and including by 95% or more. As such, the fluid reservoir of the first pliant container is configured to be reduced in volume by the applied pressure by 45 cm³ or more, such as by 100 cm³ or more, such as by 500 cm³ or more, such as by 1000 cm³ or more, such as by 2500 cm³ or more, such as by 5000 cm³ or more, such as by 10000 cm³ or more, such as by 15000 cm³ or more and including by 20000 cm³ or more. When fully compressed (i.e., little to no fluid present), the fluid reservoir may have a volume that is 1000 cm³ or less, such as 900 cm³ or less, such as 750 cm³ or less, such as 500 cm³ or less, such as 250 cm³ or less, such as 100 cm³ or less, such as 50 cm³ or less, such as 25 cm³ or less and including 10 cm³ or less.

In embodiments, the fluid reservoir of the first pliant container is configured to change shape under an applied deforming stimulus. In some embodiments, the subject fluid reservoir is formed from a flexible material, such as a material that deforms under an applied pressure of 5 psi or more, such as 10 psi or more, such as 15 psi or more, such as 20 psi or more, such as 25 psi or more, such as 50 psi or more, or 75 psi or more, including 100 psi or more, or 125 psi or more, for example 150 psi or more. For example, the fluid reservoir of the first pliant container may be formed from a thin material, such as where the walls of the fluid reservoir have a thickness of 5 mm or less, such as 3 mm or less, such as 2 mm or less, including 1 mm or less, or 0.5 mm or less, such as 0.4 mm or less, such as 0.3 mm or less, such as 0.2 mm or less and including 0.1 mm or less. In certain embodiments, the fluid reservoir is formed from a flexible material having a Young's modulus of 1 GPa or less, such as 0.9 GPa or less, such as 0.8 GPa or less, such as 0.7 GPa or less, such as 0.6 GPa or less, such as 0.5 GPa or less, such as 0.4 GPa or less, such as 0.3 GPa or less, such as 0.2 GPa or less, such as 0.1 GPa or less and including 0.01 GPa or less.

In some instances, the fluid reservoir of the first pliant container is formed from a material that is inert and substantially unreactive. In certain embodiments, the fluid reservoir is formed from a polymeric material, such as, but not limited to, polycarbonates, polyvinyl chloride (PVC), polyurethanes, polyethers, polyamides, polyimides, or copolymers of these thermoplastics, such as PETG (glycol-modified polyethylene terephthalate), among other polymeric plastic materials. In certain embodiments, the housing is formed from a polyester, where polyesters of interest may include, but are not limited to, poly(alkylene terephthalates) such as poly(ethylene terephthalate) (PET), bottle-grade PET (a copolymer made based on monoethylene glycol, terephthalic acid, and other comonomers such as isophthalic acid, cyclohexene dimethanol, etc.), poly(butylene terephthalate) (PBT), and poly(hexamethylene terephthalate); poly(alkylene adipates) such as poly(ethylene adipate), poly(1,4-butylene adipate), and poly(hexamethylene adipate); poly(alkylene suberates) such as poly(ethylene suberate); poly(alkylene sebacates) such as poly(ethylene sebacate); poly(ϵ-caprolactone) and poly(β-propiolactone); poly(alkylene isophthalates) such as poly(ethylene isophthalate); poly(alkylene 2,6-naphthalene-dicarboxylates) such as poly(ethylene 2,6-naphthalene-dicarboxylate); poly(alkylene sulfonyl-4,4′-dibenzoates) such as poly(ethylene sulfonyl-4,4′-dibenzoate); poly(p-phenylene alkylene dicarboxylates) such as poly(p-phenylene ethylene dicarboxylates); poly(trans-1,4-cyclohexanediylalkylene dicarboxylates) such as poly(trans-1,4-cyclohexanediyl ethylene dicarboxylate); poly(1,4-cyclohexane-dimethylene alkylene dicarboxylates) such as poly(1,4-cyclohexane-dimethylene ethylene dicarboxylate); poly([2.2.2]-bicyclooctane-1,4-dimethylene alkylene dicarboxylates) such as poly([2.2.2]-bicyclooctane-1,4-dimethylene ethylene dicarboxylate); lactic acid polymers and copolymers such as (S)-polylactide, (R,S)-polylactide, poly(tetramethylglycolide), and poly(lactide-co-glycolide); and polycarbonates of bisphenol A, 3,3′-dimethylbisphenol A, 3,3′,5,5′-tetrachlorobisphenol A, 3,3′,5,5′-tetramethylbisphenol A; polyamides such as poly(p-phenylene terephthalamide); polyethylene Terephthalate (e.g., Mylar™ Polyethylene Terephthalate), combinations thereof, and the like.

The fluid reservoir of the first pliant container may be any convenient shape, such as a planar shape, including a circle, oval, half-circle, crescent-shaped, star-shaped, square, triangle, rhomboid, pentagon, hexagon, heptagon, octagon, rectangle or other suitable polygon or a three-dimensional shape, such as in the shape of a sphere, cube, cone, half sphere, star, triangular prism, rectangular prism, hexagonal prism or other suitable polyhedron as well as in the shape of thin tubes.

The fluid reservoir may include one or more chambers. In some embodiments, the fluid reservoir has a single chamber for containing a single type of fluid. In other embodiments, the fluid reservoir has more than one chamber, such as 2 or more chambers, such as 3 or more chambers and including 4 or more chambers. Each chamber in a multi-chamber fluid reservoir may have one or more inlet and outlet conduits (as described in greater detail below). For instance, the two or more chambers may be in fluid communication with a single conduit. The lumens of the two or more chambers may be joined together at a Y-connector, a valve (e.g., a pinch valve), or the like.

Where the fluid reservoir includes more than one chamber, each different chamber may be configured to contain the same or different fluid. For example, a first fluid reservoir chamber may contain a first fluid and a second fluid reservoir chamber may contain a second fluid. In certain embodiments, a first pliant container having a fluid reservoir with two or more chambers may facilitate the application of two or more different types of fluids, such as a first type of sheath fluid in the first fluid reservoir chamber and the second type of sheath fluid in the second fluid reservoir chamber.

The first pliant container also includes one or more conduits in fluid communication with the fluid reservoir. In some embodiments, the fluid reservoir includes a single conduit which functions as both and inlet and outlet conduit. In other embodiments, the first pliant container includes 2 or more conduits, such as 3 or more conduits and including 5 or more conduits. Each conduit includes a proximal end in contact with the fluid reservoir and a distal end having an opening for inputting or outputting a fluid. In some instances, the first pliant container may include an inlet conduit configured for inputting a fluid into the fluid reservoir and an outlet conduit for conveying fluid out from the fluid reservoir. In other instances, the first pliant container includes two inlet conduits configured for inputting a fluid into the fluid reservoir and one outlet conduit for conveying fluid out from the fluid reservoir.

The distal end of each conduit may be configured with a valve that may be opened and closed as desired. The distal end of each inlet conduit may be reversibly or irreversibly sealed after inputting fluid into the fluid reservoir. In one example, a clamp may be applied to the distal end of the conduit to occlude the lumen. In this example, the conduit distal end may be re-opened by removing the clamp. In another example, the lumen of the conduit is irreversibly sealed, such as by press-sealing, crimping, heat sealing or by closing the lumen of the conduit with an adhesive. In certain instances, the lumen at the distal end of each conduit is self-sealing, where fluid may be added or removed from the fluid reservoir, for example using a syringe, with the lumen sealing itself in conjunction with removal of the syringe.

In certain embodiments, the distal end of one or more conduits is configured for coupling to the sample flow system of a flow cytometer. In these embodiments, the distal end may include one or more fittings which are capable of directly mating with the sample flow system. For example the distal end of the conduit may be connected to the sample flow system by a Luer slip or a Luer taper fitting, such as a Luer-Lok connection between a male Luer-Lok fitting and a female Luer-Lok fitting. In some instances, the distal end is configured for connecting to the sample flow system with a connecter, such as with a sterile connector. The connector joins and places into fluid communication the distal end of the conduit with the sample flow system. For example, the sterile connector may be already coupled to the sample flow system and coupling the distal end of the conduit to the sterile connector places the first pliant container into fluid communication with the sample flow system.

The sterile connector includes fittings for mating to the sample flow system and to the distal end of the conduit of the first pliant container. Any convenient fitting may be employed, including, but not limited to a screw-thread fitting, a Luer slip or a Luer taper fitting, such as a Luer-Lok connection between a male Luer-Lok fitting and a female Luer-Lok fitting. In certain embodiments, the connector includes a breakable seal (e.g., a single use connector) where the seal is punctured by the distal end of the conduit to connect the first pliant container to the connector.

Each conduit may have a length that varies and independently, each conduit may be 5 cm or more, such as 7 cm or more, such as 10 cm or more, such as 25 cm or more, such as 30 cm or more, such as 50 cm or more, such as 75 cm or more, such as 100 cm or more, such as 250 cm or more and including 500 cm or more. The lumen diameter of each conduit may also vary and may be 0.5 mm or more, such as 0.75 mm or more, such as 1 mm or more, such as 1.5 mm or more, such as 2 mm or more, such as 5 mm or more, such as 10 mm or more, such as 25 mm or more and including 50 mm or more. For example, depending on the desired flow rate of conveying fluid from the fluid reservoir through and outlet conduit, the lumen diameter may range from 0.5 mm to 50 cm, such as from 1 mm to 25 mm and including from 5 mm to 15 mm.

The conduits of the first pliant container may be formed from the same material as the fluid reservoir or may be different or a combination thereof, as desired. In some embodiments, the conduits of the first pliant container are formed from the same material and the first pliant container is a single integrated pliant container having a fluid reservoir and one or more conduits. In other embodiments, the conduits of the first pliant container are formed from a different material as the fluid reservoir and the conduits are irreversibly affixed together. Like the fluid reservoir, each conduit may be formed from a thin material, such as where the walls of the conduit have a thickness of 5 mm or less, such as 3 mm or less, such as 2 mm or less, including 1 mm or less, or 0.5 mm or less, such as 0.4 mm or less, such as 0.3 mm or less, such as 0.2 mm or less and including 0.1 mm or less. In certain embodiments, the conduit is formed from a flexible material having a Young's modulus of 1 GPa or less, such as 0.9 GPa or less, such as 0.8 GPa or less, such as 0.7 GPa or less, such as 0.6 GPa or less, such as 0.5 GPa or less, such as 0.4 GPa or less, such as 0.3 GPa or less, such as 0.2 GPa or less, such as 0.1 GPa or less and including 0.01 GPa or less. In certain embodiments, the conduits are formed from a polymeric material, such as, but not limited to, e.g., as described above, including but not limited to: polyvinyl chloride (PVC), ethyl vinyl acetate (EVA), polyethylene, polypropylene, combinations thereof, and the like.

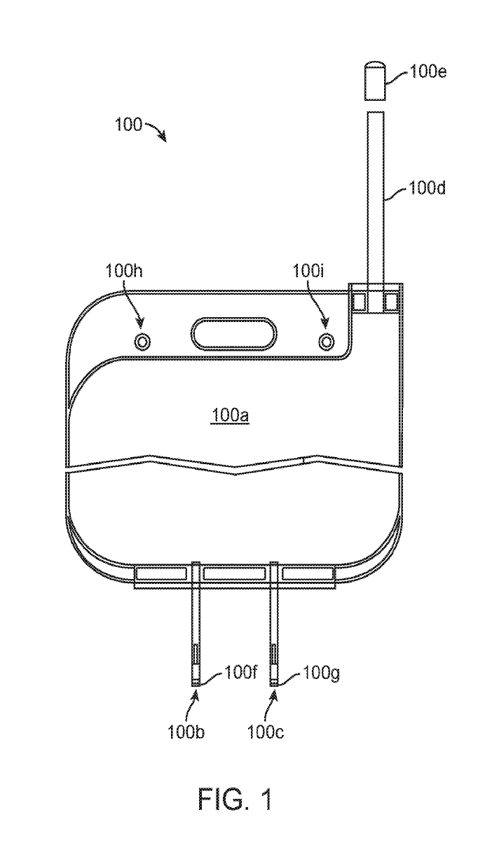

FIG. 1 depicts a first pliant container for dispensing a fluid (e.g., a sheath fluid) according to certain embodiments. First pliant container 100 includes two inlet conduits 100b and 100c for inputting a fluid (e.g., sheath fluid) into fluid reservoir 100a. Each inlet conduit 100b and 100c may include a fitting 100f and 100g, respectively, such as a male or female Luer fitting. To convey fluid from fluid reservoir 100a, first pliant container 100 includes outlet conduit 100d that is in fluid communication with fluid reservoir 100a. Outlet conduit 100d may include a fitting 100e at the distal end, such as to mate with a sterile connector or directly to an inlet to a sample flow system of a flow cytometer. First pliant container 100 includes holes 100h and 100i for affixing to the interior of a housing.

Pliant fluid dispensing structures also include a second pliant container. The second pliant container includes a gas reservoir and an inlet conduit in gaseous communication with the gas reservoir. As discussed in greater detail below, the gas reservoir of the second pliant container is configured to expand in response to input of a gas, where the expansion applies an amount of pressure to the reservoir of the first pliant container sufficient to convey fluid out of the fluid reservoir of the first pliant container. In the subject pliant fluid dispensing structures, the second pliant container is stably associated with the first pliant container. By “stably associated” is meant that second pliant container maintains a position relative to the first pliant container such that expansion of the gas reservoir of the second pliant container is sufficient to apply pressure to the fluid reservoir of the first pliant container. In some embodiments, the second pliant container in the subject pliant fluid dispensing structures is positioned at a distance of 5 mm or less from the first pliant container, such as 4 mm or less, such as 3 mm or less, such as 2 mm or less and including 1 mm or less from the first pliant container. In other embodiments, the second pliant container is in contact with the first pliant container. For example, the gas reservoir of the second pliant container may be in contact with the fluid reservoir of the first pliant container. All or part of the fluid reservoir of the first pliant container may be in contact with the gas reservoir of the second pliant container, such as where 10% or more of the outside surface of the fluid reservoir of the first pliant container is in contact with the gas reservoir of the second pliant container, such as 25% or more, such as 50% or more, such as 75% or more, such as 90% or more and including 95% or more. In some embodiments, the entire outside surface (i.e., 100%) of the fluid reservoir of the first pliant container is in contact with the gas reservoir of the second pliant container. In certain instances, the second pliant container is positioned to contact with one or more discrete regions of the fluid reservoir of the first pliant container, such as 2 or more discrete regions, such as 3 or more, such as 4 or more, such as 5 or more and including 10 or more discrete regions of the fluid reservoir. Each region may be any convenient shape, such as in the shape of a circle, oval, half-circle, crescent-shaped, star-shaped, square, triangle, rhomboid, pentagon, hexagon, heptagon, octagon, rectangle or some other convenient shape. Depending on the size of the fluid reservoir, each discrete region may be contacted by the second pliant container may be 1 cm² or greater, such as 2 cm² or greater, such as 3 cm² or greater, such as 5 cm² or greater, such as 10 cm² or greater, such as 15 cm² or greater and including 25 cm² or greater.

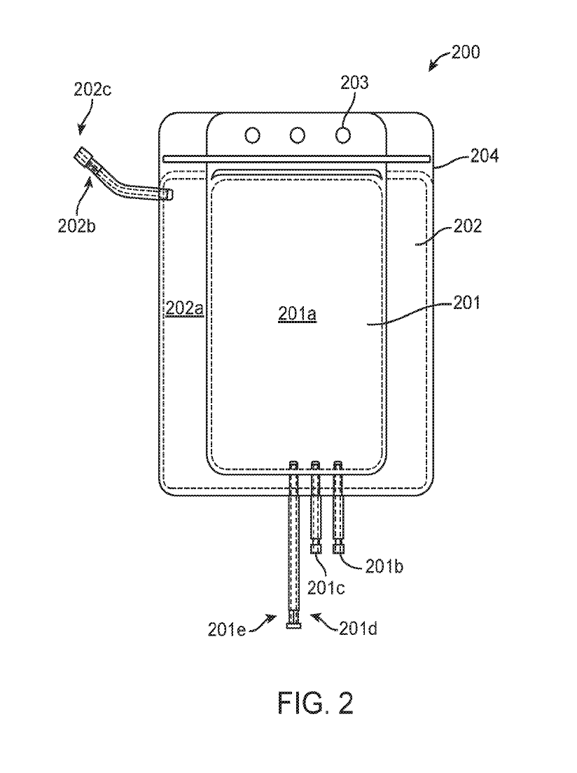

In certain embodiments, the first pliant container is positioned at least partially within the second pliant container. For example, the gas reservoir of the second pliant container may be in the shape of a pouch where the first pliant container is positioned within an interior space of the pouch formed by the second pliant container. Depending on the size of the fluid reservoir and gas reservoir, all of part of the reservoir of the first pliant container may be positioned within the second pliant container, such as where 10% or more of the fluid reservoir being positioned within the second pliant container, such as 25% or more, such as 50% or more, such as 75% or more, such as 90% or more and including 95% or more. In certain embodiments, the fluid reservoir of the first pliant container is wholly (i.e., 100%) positioned within the second pliant container. In certain instances, the fluid reservoir of the first pliant container is wholly positioned and sealed within the second pliant container. FIG. 2 depicts a pliant fluid dispensing container structure according to certain embodiments. Pliant fluid dispensing container structure 200 includes a first pliant container 201 and a second pliant container 202. First pliant container 201 includes two inlet conduits 201b and 201c for inputting a fluid (e.g., sheath fluid) into fluid reservoir 201a. To convey fluid from fluid reservoir 201a, first pliant container 201 includes outlet conduit 201d that is in fluid communication with fluid reservoir 201a. Outlet conduit 201d may include a fitting 201e at the distal end, such as to mate with a sterile connector or directly to an inlet to a sample flow system of a flow cytometer. First pliant container 201 is wholly positioned within second pliant container 202 and sealed along pinch line 204. To facilitate input of a gas into gas reservoir 202a of second pliant container 202, an inlet conduit 202b is in fluid communication with gas reservoir 202a. Inlet conduit 202b may also include a fitting 202c at the distal end, such as to mate with a connector or directly to a gas source. Each of first pliant container 201 and second pliant container 202 include a hole 203 for affixing to the interior of a housing.

When fully compressed (i.e., minimum fluidic capacity), the fluid reservoir may have a volume that ranges from 50 cm³ to 10000 cm³ or less, such as from 100 cm³ to 9000 cm³, such as from 750 cm³ to 8000 cm³, such as from 500 cm³ to 7500 cm³, such as from 250 cm³ to 5000 cm³ and including from 500 cm³ to 4000 cm³.

As discussed above, a gas is inputted to expand (i.e., increase in volume) the gas reservoir. In some embodiments, the volume of the gas reservoir is increased by 10% or more as a result of the expansion by gas input, such as by 15% or more, such as by 25% or more, such as by 50% or more, such as by 60% or more, such as by 75% or more, such as by 90% or more and including by 95% or more. In certain instances, the volume of the gas reservoir is increased by 2-fold or more as a result of expansion by gas input, such as by 3-fold or more, such as by 5-fold or more and including by 10-fold or more. As such, the gas reservoir may be configured to increase in volume by 50 cm³ or more, such as by 100 cm³ or more, such as by 250 cm³ or more, such as by 500 cm³ or more, such as by 1000 cm³ or more, such as by 5000 cm³ or more, such as by 10000 cm³ or more, such as by 20000 cm³ or more and including by 25000 cm³ or more. When fully expanded (i.e., maximum gas pressure), the gas reservoir may have a volume that varies, ranging from 50 cm³ to 25000 cm³, such as from 75 cm³ to 20000 cm³, such as from 100 cm³ to 15000 cm³, such as from 250 cm³ to 10000 cm³, such as from 500 cm³ to 7500 cm³, such as from 750 cm³ to 6000 cm³ and including from 1000 cm³ to 5000 cm³.

In embodiments, the gas reservoir of the second pliant container is configured to expand in response to an input of a gas (i.e., positive gas pressure). In some embodiments, the subject gas reservoirs are formed from a flexible material, such as a material that expands in response to a positive gas pressure of 5 psi or more, such as 10 psi or more, such as 15 psi or more, such as 20 psi or more, such as 25 psi or more, such as 50 psi or more, or 75 psi or more, including 100 psi or more, or 125 psi or more, for example 150 psi or more. For example, the gas reservoir second pliant container may be formed from a thin material, such as where the walls of the gas reservoir have a thickness of 5 mm or less, such as 3 mm or less, such as 2 mm or less, including 1 mm or less, or 0.5 mm or less, such as 0.4 mm or less, such as 0.3 mm or less, such as 0.2 mm or less and including 0.1 mm or less. In certain embodiments, the gas reservoir is formed from a flexible material having a Young's modulus of 1 GPa or less, such as 0.9 GPa or less, such as 0.8 GPa or less, such as 0.7 GPa or less, such as 0.6 GPa or less, such as 0.5 GPa or less, such as 0.4 GPa or less, such as 0.3 GPa or less, such as 0.2 GPa or less, such as 0.1 GPa or less and including 0.01 GPa or less.

In some instances, the gas reservoir of the second pliant container is formed from a polymeric material, such as, but not limited to, polycarbonates, polyvinyl chloride (PVC), polyurethanes, polyethers, polyamides, polyimides, or copolymers of these thermoplastics, such as PETG (glycol-modified polyethylene terephthalate), among other polymeric plastic materials. In certain embodiments, the housing is formed from a polyester, where polyesters of interest may include, but are not limited to, poly(alkylene terephthalates) such as poly(ethylene terephthalate) (PET), bottle-grade PET (a copolymer made based on monoethylene glycol, terephthalic acid, and other comonomers such as isophthalic acid, cyclohexene dimethanol, etc.), poly(butylene terephthalate) (PBT), and poly(hexamethylene terephthalate); poly(alkylene adipates) such as poly(ethylene adipate), poly(1,4-butylene adipate), and poly(hexamethylene adipate); poly(alkylene suberates) such as poly(ethylene suberate); poly(alkylene sebacates) such as poly(ethylene sebacate); poly(ϵ-caprolactone) and poly(β-propiolactone); poly(alkylene isophthalates) such as poly(ethylene isophthalate); poly(alkylene 2,6-naphthalene-dicarboxylates) such as poly(ethylene 2,6-naphthalene-dicarboxylate); poly(alkylene sulfonyl-4,4′-dibenzoates) such as poly(ethylene sulfonyl-4,4′-dibenzoate); poly(p-phenylene alkylene dicarboxylates) such as poly(p-phenylene ethylene dicarboxylates); poly(trans-1,4-cyclohexanediyl alkylene dicarboxylates) such as poly(trans-1,4-cyclohexanediyl ethylene dicarboxylate); poly(1,4-cyclohexane-dimethylene alkylene dicarboxylates) such as poly(1,4-cyclohexane-dimethylene ethylene dicarboxylate); poly([2.2.2]-bicyclooctane-1,4-dimethylene alkylene dicarboxylates) such as poly([2.2.2]-bicyclooctane-1,4-dimethylene ethylene dicarboxylate); lactic acid polymers and copolymers such as (S)-polylactide, (R,S)-polylactide, poly(tetramethylglycolide), and poly(lactide-co-glycolide); and polycarbonates of bisphenol A, 3,3′-dimethylbisphenol A, 3,3′,5,5′-tetrachlorobisphenol A, 3,3′,5,5′-tetramethylbisphenol A; polyamides such as poly(p-phenylene terephthalamide); polyethylene Terephthalate (e.g., Mylar™ Polyethylene Terephthalate), combinations thereof, and the like.

The gas reservoir of the second pliant container may be any convenient shape, such as a planar shape, including a circle, oval, half-circle, crescent-shaped, star-shaped, square, triangle, rhomboid, pentagon, hexagon, heptagon, octagon, rectangle or other suitable polygon or a three-dimensional shape, such as in the shape of a cube, cone, half sphere, star, triangular prism, rectangular prism, hexagonal prism or other suitable polyhedron as well as in the shape of thin tubes.

The gas reservoir may be configured to have one or more chambers. In some embodiments, the gas reservoir has a single chamber for containing a single gas. In other embodiments, the gas reservoir has more than one chamber, such as 2 or more chambers, such as 3 or more chambers and including 4 or more chambers. Where more than one chamber is present, the chambers may have the same or different sizes, or a combination thereof. Each chamber in a multi-chamber gas reservoir may have one or more inlet and outlet conduits (as described in greater detail below). For instance, the two or more chambers may be in gaseous communication with a single inlet/outlet. The lumens of the two or more chambers may be joined together at a Y-connector, a valve (e.g., a check valve or a pinch valve), or the like.

In some embodiments where the gas reservoir includes more than one chamber, each different chamber may be configured to be in gaseous communication with the same or different gas source. In one example, a first gas reservoir chamber may be in gaseous communication with a first gas source (e.g., air) and a second gas reservoir chamber in gaseous communication with a second gas source (e.g., nitrogen or argon). In other embodiments where the gas reservoir includes more than one chamber, each different chamber may be configured to be expanded to a different size.

To fill the gaseous reservoir with a gas, the second pliant containers include one or more inlet conduits that are in gaseous communication with the gas reservoir. In some embodiments, the second pliant container includes a single conduit which functions as both an inlet and outlet for the source of gas. In other embodiments, the second pliant container includes 2 or more conduits, such as 3 or more conduits and including 5 or more conduits. Each conduit includes a proximal end in contact with the gas reservoir and a distal end having an opening for inputting or outputting a gas. In some instances, the second pliant container may include an inlet conduit configured for connecting to a source of gas and an outlet conduit for releasing gas pressure from the gas reservoir. In other instances, the second pliant container includes two inlet conduits configured for connecting to two sources of gas and one outlet conduit for releasing gas pressure from the gas reservoir.

In embodiments, the distal end of one or more conduits is configured for coupling to a source of a gas. As described in greater detail below, the gas source may be any convenient gas source, such as compressor or gas tank connected to a regulator (mechanical or computerized). In these embodiments, the distal end may include one or more fittings which are capable of directly mating with the gas source. For example the distal end of the conduit may be connected to the gas source a high pressure screw fitting, by a Luer slip or a Luer taper fitting, such as a Luer-Lok connection between a male Luer-Lok fitting and a female Luer-Lok fitting.

In some embodiments, the distal end of the conduit is connected to the gas source through a connector. The connector joins and places the gas reservoir of the second pliant container into gaseous communication with the gas source. The connector includes fittings for mating to the gas source and to the distal end of the conduit of the second pliant container. Any convenient fitting may be employed, including, but not limited to a screw-thread fitting, a Luer slip or a Luer taper fitting, such as a Luer-Lok connection between a male Luer-Lok fitting and a female Luer-Lok fitting. In certain embodiments, the connector includes a breakable seal (e.g., a single use connector) where the seal is punctured by the distal end of the conduit to connect the second pliant container to the connector.

Each conduit may have a length that varies and independently, each conduit may be 5 cm or more, such as 7 cm or more, such as 10 cm or more, such as 25 cm or more, such as 30 cm or more, such as 50 cm or more, such as 75 cm or more, such as 100 cm or more, such as 250 cm or more and including 500 cm or more. The lumen diameter of each conduit may also vary and may be 0.5 mm or more, such as 0.75 mm or more, such as 1 mm or more, such as 1.5 mm or more, such as 2 mm or more, such as 5 mm or more, such as 10 mm or more, such as 25 mm or more and including 50 mm or more. For example, depending on the desired expansion rate of the gas reservoir, the lumen diameter may range from 0.5 mm to 50 cm, such as from 1 mm to 25 mm and including from 5 mm to 15 mm.

The conduits of the second pliant container may be formed from the same material as the gas reservoir or may be different or a combination thereof, as desired. In some embodiments, the conduits of the second pliant container are formed from the same material and the second pliant container is a single integrated container having a gas reservoir and one or more conduits. In other embodiments, the conduits of the second pliant container are formed from a different material as the fluid reservoir and the conduits are irreversibly affixed together. Like the gas reservoir, each conduit may be formed from a thin material, such as where the walls of the conduit have a thickness of 5 mm or less, such as 3 mm or less, such as 2 mm or less, including 1 mm or less, or 0.5 mm or less, such as 0.4 mm or less, such as 0.3 mm or less, such as 0.2 mm or less and including 0.1 mm or less. In certain embodiments, the conduit is formed from a flexible material having a Young's modulus of 1 GPa or less, such as 0.9 GPa or less, such as 0.8 GPa or less, such as 0.7 GPa or less, such as 0.6 GPa or less, such as 0.5 GPa or less, such as 0.4 GPa or less, such as 0.3 GPa or less, such as 0.2 GPa or less, such as 0.1 GPa or less and including 0.01 GPa or less. In certain embodiments, the conduits are formed from a polymeric material, such as, but not limited to, polyvinyl chloride (PVC), ethyl vinyl acetate (EVA), polyethylene, polypropylene, combinations thereof, and the like.

In order to control the rate of expansion by the gas reservoir during input of the gas or to prevent overfilling the gas reservoir, the second pliant container may also include one or more valves configured to regulate the pressure inside the gas reservoir. For example, the value may be a check valve, such as a ball check valve. During use, the ball may be positioned in the check valve, sealing the gas reservoir and thus allowing pressure to build up inside the gas reservoir in a controlled manner and to expand the desired amount to apply pressure to the fluid reservoir of the first pliant container. In certain embodiments, one or more conduits of the second pliant container may include a pressure release valve which is configured to release gas from the gas reservoir when the pressure of the gas reservoir has reached a predetermined threshold or when the gas reservoir is expanding at a rate that is greater than desired.

In some embodiments, the second pliant container includes a gas pressure sensor to monitor the pressure in the gas reservoir. Any convenient pressure sensing protocol may be employed and may include but is not limited to absolute pressure sensors, gauge pressure sensors, vacuum pressure sensors, differential pressure sensors, such as a piezoresistive strain gauges, capacitive pressure sensors, electromagnetic pressure sensors, piezoelectric pressure sensors, potentiometric pressure sensors, resonant pressure sensors, among other types of pressure sensors. In certain instances, the pressure sensor may be in operative communication with the source of gas and provide feedback to the source of gas based on the measured gas pressure. In one example, the pressure sensor may provide feedback to the source of gas to increase the rate of gas input. In another example the pressure sensor may provide feedback to the source of gas to decrease the rate of gas input. In yet another example, the pressure sensor may provide feedback to the source of gas to stop gas input into the gas reservoir of the second pliant container.

One or more of the first pliant container and the second pliant container may include a fastener for releasably attaching the pliant containers to an interior wall of the housing. In some instances, the first pliant container includes fastener for releasably attaching to an interior wall of the housing. In other instances, the second pliant container includes a fastener. In yet other instances, both the first pliant container and the second pliant container include fasteners. Any suitable fastening protocol may be employed so long as it is sufficient to affix the pliant containers to the housing and may include, but are not limited to, hook and loop fasteners, latches, notches, grooves, pins, tethers, hinges, Velcro, non-permanent adhesives or a combination thereof. In certain embodiments, the first pliant container and the second pliant container include one or more holes for hanging onto a hook within on an interior wall of the housing. In other embodiments, the first pliant container and the second pliant container include a hook and loop fastener.

### Systems for Dispensing a Fluid

Aspects of the present disclosure also include systems for dispensing a fluid, such as a sheath fluid into a sample flow system of a flow cytometer. Systems according to certain embodiments include a housing, a first pliant container and a second pliant container in the housing where the first pliant container includes a fluid reservoir and a conduit that has a proximal end and a distal end, where the proximal end is fluidically coupled to the fluid reservoir; and the second pliant container includes a gas reservoir and a port in gaseous communication with the gas reservoir where the second pliant container is positioned in the housing with the first pliant container and is configured to apply pressure to the fluid reservoir of the first pliant container to convey fluid from the distal end of the conduit. In certain embodiments, systems of interest also include a source of a gas for inputting into the second pliant container. In other embodiments, systems also include one or more sensors for measuring and monitoring the flow of fluid conveyed from the first pliant container and for measuring and regulating gas pressure into the second pliant container.

As discussed below, the gas reservoir of the second pliant container is configured to expand in response to being filled with a gas, where expansion applies an amount of pressure to the reservoir of the first pliant container that is sufficient to convey fluid from the fluid reservoir of the first pliant container. In some embodiments, the first pliant container is positioned adjacent to, but not in contact with the second pliant container in the housing. In some instances, the first pliant container is positioned adjacent to the second pliant container by 20 mm or less, such as 15 mm or less, such as 10 mm or less, such as 5 mm or less, such as 4 mm or less, such as 3 mm or less, such as 2 mm or less and including 1 mm or less. In these embodiments, input of gas into the gas reservoir of the second pliant container results in expansion of the gas reservoir such that the gas reservoir comes into contact with the fluid reservoir of the first pliant container. As the gas reservoir expands, the fluid reservoir of the first pliant container presses against one or more walls of the housing such that the pressure exerted onto the fluid reservoir is sufficient to convey fluid out of a conduit of the first pliant container.

In other embodiments, the first pliant container is positioned to be in contact with the second pliant container. In other words, within the housing the gas reservoir of the second pliant container is touching the fluid reservoir of the first pliant container. All or part of the fluid reservoir of the first pliant container may be in contact with the gas reservoir of the second pliant container, such as where 10% or more of the outside surface of the fluid reservoir of the first pliant container is in contact with the gas reservoir of the second pliant container, such as 25% or more, such as 50% or more, such as 75% or more, such as 90% or more and including 95% or more. In some embodiments, the entire outside surface (i.e., 100%) of the fluid reservoir of the first pliant container is in contact with the gas reservoir of the second pliant container. In certain instances, one or more discrete regions of the gas reservoir of the second pliant container are in contact with fluid reservoir of the first pliant container, such as 2 or more discrete regions, such as 3 or more, such as 4 or more, such as 5 or more and including 10 or more discrete regions of the fluid reservoir. Each region may be any convenient shape, such as in the shape of a circle, oval, half-circle, crescent-shaped, star-shaped, square, triangle, rhomboid, pentagon, hexagon, heptagon, octagon, rectangle or some other convenient shape. Depending on the size of the fluid reservoir and the gas reservoir, each discrete region may be 1 cm² or greater, such as 2 cm² or greater, such as 3 cm² or greater, such as 5 cm² or greater, such as 10 cm² or greater, such as 15 cm² or greater and including 25 cm² or greater.

In other embodiments, the first pliant container is stably associated with and positioned at least partially within the second pliant container. For example, the gas reservoir of the second pliant container may be in the shape of a pouch where the first pliant container is positioned within an interior space of the pouch formed by the second pliant container. Depending on the size of the fluid reservoir and gas reservoir, all of part of the reservoir of the first pliant container may be positioned within the second pliant container, such as where 10% or more of the fluid reservoir being positioned within the second pliant container, such as 25% or more, such as 50% or more, such as 75% or more, such as 90% or more and including 95% or more. In certain embodiments, the fluid reservoir of the first pliant container is wholly (i.e., 100%) positioned within the second pliant container. One or more of the first pliant container and the second pliant container may include a fastener for releasably attaching the pliant containers to an interior wall of the housing. In some instances, the first pliant container includes fastener for releasably attaching to an interior wall of the housing. In other instances, the second pliant container includes a fastener. In yet other instances, both the first pliant container and the second pliant container include fasteners. As discussed above, fasteners may include any convenient protocol for affixing the pliant containers to the housing and may include, but are not limited to, hook and loop fasteners (e.g., VELCRO™ hook and loop fasteners), latches, notches, grooves, pins, tethers, hinges, non-permanent adhesives or a combination thereof. In certain embodiments, the first pliant container and the second pliant container include one or more holes for hanging onto a hook on an interior wall of the housing. In other embodiments, the first pliant container and the second pliant container include hook and loop fasteners.

In certain embodiments, the subject systems are configured for dispensing a sheath fluid, such as to a sample flow system of a flow cytometer. For example, the subject systems may be coupled to and configured to deliver a sheath fluid to a flow cytometer, such as those described in those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ and FACSCanto II™ flow cytometers, BD Biosciences FACSVantage™, BD Biosciences FACSort™, BD Biosciences FACSCount™, BD Biosciences FACScan™, and BD Biosciences FACSCalibur™ systems, BD Biosciences Influx™ cell sorter, BD Biosciences Accuri™ C6 flow cytometer; BD Biosciences LSRFortessa™ flow cytometer, BD Biosciences LSRFortessa™ X-20 flow cytometer, BD Biosciences FACSVerse™ flow cytometer, BD Biosciences FACSAria™ III and BD FACSAria™ Fusion flow cytometers, BD Biosciences FACSJazz™ flow cytometer, or the like. Flow cytometer systems of interest are further described in U.S. Pat. Nos. 3,960,449; 4,347,935; 4,667,830; 4,704,891; 4,770,992; 5,030,002; 5,040,890; 5,047,321; 5,245,318; 5,317,162; 5,464,581; 5,483,469; 5,602,039; 5,620,842; 5,627,040; 5,643,796; 5,700,692; 6,372,506; 6,809,804; 6,813,017; 6,821,740; 7,129,505; 7,201,875; 7,544,326; 8,140,300; 8,233,146; 8,753,573; 8,975,595; 9,092,034; 9,095,494 and 9,097,640; the disclosures of which are herein incorporated by reference.

In these embodiments, the distal end of the outlet conduit of the first pliant container may be coupled to an inlet of the sample flow system. As described above, the distal end of the outlet conduit may include one or more fittings which are capable of directly mating with the sample flow system. For example the distal end of the conduit includes a Luer slip or a Luer taper fitting, such as a Luer-Lok connection between a male Luer-Lok fitting and a female Luer-Lok fitting. In some instances, systems of interest include a sterile connector to connect the sample flow system to the outlet conduit of the first pliant container. The sterile connector may include fittings, such as a screw-thread fitting, a Luer slip or a Luer taper fitting. In certain embodiments, the sterile connector includes a breakable seal (e.g., a single use connector) where the seal is punctured by the distal end of the conduit to connect the first pliant container to the connector.

In certain embodiments, systems further include one or more gas sources in gaseous communication with an inlet conduit of the second pliant container. In some instances, the gas source is a pressurized gas, such as, but not limited to a pressurized gas cylinder, a compressor, and the like. In certain instances, the pressurized gas has a pressure of 25 psi or more, such as 50 psi or more, or 75 psi or more, including 100 psi or more, or 125 psi or more, for example 150 psi or more. The pressurized gas may be any convenient type of gas suitable for creating a positive pressure within the gas reservoir of the second pliant container. For instance, the pressurized gas may include air, nitrogen, argon, and the like.

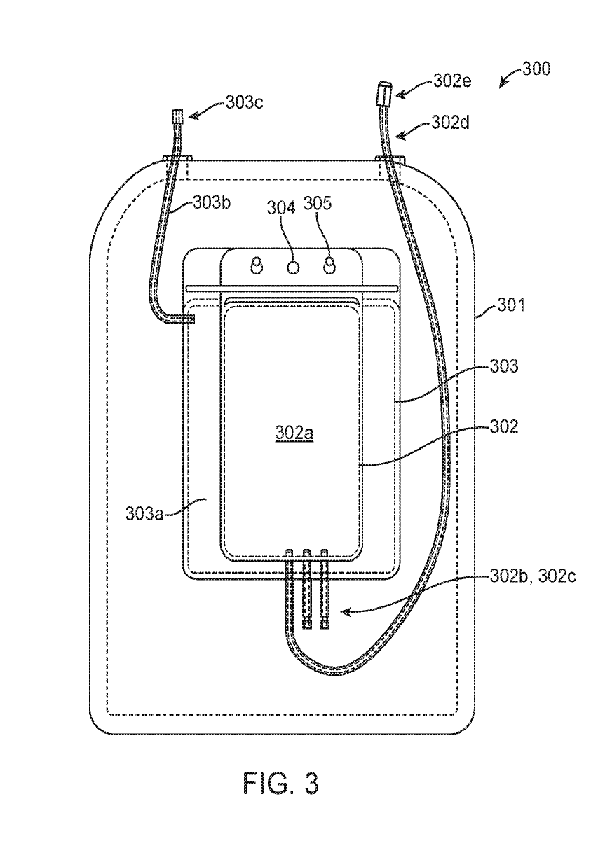

FIG. 3 depicts a system for providing a fluid having a pliant fluid dispensing container structure according to certain embodiments. System 300 includes a housing 301 and a pliant fluid dispensing container structure positioned therein. The pliant fluid dispensing container structure includes a first pliant container 302 and a second pliant container 303. First pliant container 302 includes two inlet conduits 302b and 302c for inputting a fluid (e.g., sheath fluid) into fluid reservoir 302a. To convey fluid from fluid reservoir 302a, first pliant container 302 includes outlet conduit 302d that is in fluid communication with fluid reservoir 302a. Outlet conduit 302d may include a fitting 302e at the distal end, such as to mate with a sterile connector or directly to an inlet to a sample flow system of a flow cytometer. First pliant container 302 is wholly positioned within second pliant container 303. To facilitate input of a gas into gas reservoir 303a of second pliant container 303, an inlet conduit 303b is in fluid communication with gas reservoir 303a. Inlet conduit 303b may also include a fitting 303c at the distal end, such as to mate with a connector or directly to a gas source. Each of first pliant container 302 and second pliant container 303 include a hole 304 for hanging on a hook 305 on an interior wall of housing 301.

As described in greater detail below, the gas source is configured to input gas into the second pliant container such that the gas reservoir of the second pliant container exerts a pressure onto the fluid reservoir of the first pliant container to convey fluid out of the fluid reservoir at a flow rate of 1 μL/sec or more, such as 2 μL/sec or more, such as 5 μL/sec or more, such as 10 μL/sec or more, such as 25 μL/sec or more, such as 50 μL/sec or more, such as 100 μL/sec or more, such as 250 μL/sec or more, such as 500 μL/sec or more, such as 750 μL/sec or more and including 1000 μL/sec or more.

In some instances, the subject systems may include one or more valves to control the rate of output from the gas source or to prevent overfilling the gas reservoir. In one example, the subject systems include a check valve, such as a ball check valve, positioned between the gas source and the inlet conduit of the second pliant container. In another example, a pressure release valve may be positioned between the gas source and the inlet conduit of the second pliant container. In other instances, systems of interest include one or more gas pressure sensors to monitor gas pressure. Any convenient pressure sensing protocol may be employed and may include but is not limited to absolute pressure sensors, gauge pressure sensors, vacuum pressure sensors, differential pressure sensors, such as a piezoresistive strain gauges, capacitive pressure sensors, electromagnetic pressure sensors, piezoelectric pressure sensors, potentiometric pressure sensors, resonant pressure sensors, among other types of pressure sensors.

The subject systems, in certain embodiments, further include a feedback monitor configured to assess the flow rate of fluid outputted from the outlet conduit of the first pliant container and the gas pressure is the gas reservoir of the second pliant container. In some embodiments, feedback monitors collect real-time data about the flow rate of fluid output and gas pressure. In other embodiments, feedback monitors are configured to assess the flow rate and gas pressure at regular intervals, such as every 1 minute, every 5 minutes, every 10 minutes, every 30 minutes, every 60 minutes or some other interval.

In embodiments of the present disclosure, feedback monitors may also be configured to evaluate the flow rate of fluid outputted from the outlet conduit of the first pliant container and the gas pressure in the gas reservoir of the second pliant container and identify any desired adjustments for outputting fluid from the first pliant container, where the adjustments may in certain instances improve one or more of the flow rate, consistency and uniformity. In certain embodiments, the feedback monitor includes a processor which is configured to evaluate the flow rate of fluid outputted from the outlet conduit of the first pliant container and the gas pressure is the gas reservoir of the second pliant container and to identify if any desired adjustments are needed. In some embodiments, feedback monitors are configured to evaluate fluid flow rate and gas pressure and determine if an increase or decrease in gas input into the gas reservoir of the second pliant container is required, such as to increase or decrease fluid flow from the first pliant container. In certain instances, the feedback monitor is configured identify that a decrease or stop in gas output from the gas source is necessary or desired when the positive pressure within the gas reservoir is too high or increasing too quickly. In other instances, the feedback monitor is configured to identify that an increase in gas output from the gas source is necessary or desired when the positive pressure within the gas reservoir is too low or increasing too slowly.

In certain aspects, feedback monitors are configured to allow the subject systems to operate in a closed-loop fashion. For example, in some embodiments the feedback monitor may assess the flow rate of fluid outputted from the outlet conduit of the first pliant container and the gas pressure is the gas reservoir of the second pliant container and may change one or more parameters of the subject systems on a substantially real-time basis to automatically obtain more effective results as desired. In certain aspects, such a closed-loop system may involve applying one or more statistical or learning machine algorithms, such as genetic algorithms, neural networks, hidden Markov models, Bayesian networks, and the like.

### Methods for Dispensing a Fluid

Aspects of the present disclosure also include methods for dispensing a fluid, such as a sheath fluid into a sample flow system of a flow cytometer. As described above, the subject fluid dispensing systems include a housing, a first pliant container and a second pliant container in the housing where the first pliant container includes a fluid reservoir and a conduit that has a proximal end and a distal end where the proximal end is fluidically coupled to the fluid reservoir; and the second pliant container includes a gas reservoir and a port in gaseous communication with the gas reservoir where the second pliant container is positioned in the housing with the first pliant container and is configured to apply pressure to the fluid reservoir of the first pliant container to convey fluid from the distal end of the conduit.

In practicing the subject methods according to certain embodiments, a gas is inputted from a gas source into an inlet conduit to fill the gas reservoir of the second pliant container. The inputted gas may be any convenient gas, such as air, nitrogen, argon or a combination thereof. In certain instances, more than one type of gas is inputted into the gas reservoir, such as 2 different types of gas, such as 3 different types of gas and including 5 different types of gas.

In some embodiments, the gas source contains a pressurized gas, such as gas from a gas cylinder, compressor or the like. In certain instances, the pressurized gas is under a pressure of 25 psi or more, such as 50 psi or more, or 75 psi or more, including 100 psi or more, or 125 psi or more, for example 150 psi or more. Depending on the size of the gas reservoir and the flow rate of conveying fluid from the first pliant container desired, the input rate of gas flow into the second pliant container may vary and may be 0.01 L/minute or more, such as 0.05 L/minute or more, such as 0.1 L/minute or more, such as 0.5 L/minute or more, such as 1 L/minute or more, such as 1.5 L/minute or more, such as 2 L/minute or more, such as 3 L/minute or more, such as 5 L/minute or more and including 10 L/minute or more. Gas may be inputted into the gas reservoir of the second pliant container from one or more gas sources, such as 2 or more gas sources, such as 3 or more gas sources, such as 4 or more gas sources and including 5 or more gas source. For example, in some embodiments, methods include inputting gas into the gas reservoir of the second pliant container with a series of gas cylinders.

Depending on the desired flow of fluid from the fluid reservoir of the first pliant container, the gas may be inputted into the gas reservoir of the second pliant container continuously or in discrete intervals. In some instances, methods include inputting gas from the gas source into the gas reservoir of the first pliant container continuously. In other instances, the gas is inputted in discrete intervals, such as inputting gas for an interval of 5 seconds or more, such as for 10 seconds or more, such as for 15 seconds or more, such as from 30 seconds or more, such as for 60 seconds or more, such as for 120 seconds or more, such as for 240 seconds or more, such as for 300 seconds or more and including for 600 seconds or more.

Where the gas is inputted in discrete intervals, the time period between each interval may also vary, as desired, being separated independently by a delay of 1 second or more, such as 2 seconds or more, such as 5 seconds or more, such as 10 seconds or more, such as 15 seconds or more, such as 30 seconds or more and including 60 seconds or more. The time period between each discrete interval for inputting gas from the gas source may be the same or different.

As discussed below, in some embodiments, systems of interest may also include a computer having programming for controlling input of the gas from a gas source into the second pliant container. In certain instances, methods may include entering into a graphical user interface of the computer (e.g., with a keyboard and mouse) a schedule or protocol for conveying gas from the gas source. For example, protocols may include one or more parameters such as the size of the gas reservoir of the second pliant container, type of gas (e.g., nitrogen, argon, air or a combination thereof), gas flow rate, total gas volume, gas input interval duration as well as duration between each gas input interval.

In some embodiments, methods also include coupling an inlet conduit of the second pliant container to the gas source. The inlet conduit is in gaseous communication with the gas reservoir and may include one or more fittings which are capable of directly mating with the gas source. For example, methods may include connecting the distal end of the conduit to the gas source with a high pressure screw fitting, with a Luer slip or a Luer taper fitting, such as a Luer-Lok connection between a male Luer-Lok fitting and a female Luer-Lok fitting. In certain embodiments, methods include connecting a connector to the inlet conduit of the second pliant container and then coupling the connector to the gas source. The inlet conduit of the second pliant container may likewise be coupled to the connected with a high pressure screw-thread fitting, a Luer slip or a Luer taper fitting, such as a Luer-Lok connection between a male Luer-Lok fitting and a female Luer-Lok fitting. In certain embodiments, the connector includes a breakable seal (e.g., a single use connector) and to couple the inlet conduit, the seal is punctured with distal end of the conduit. A second breakable seal may be employed to couple the gas source to the connector.

As summarized above, the gas reservoir of the second pliant container is configured to expand in response to the input of gas and apply an amount of pressure to the fluid reservoir of the first pliant container in the housing. As a result of the exerted pressure by the second pliant container, fluid is conveyed from the fluid reservoir through an outlet conduit. Depending on the orientation of the first pliant container with respect the second pliant container in the housing, fluid may be conveyed from the fluid reservoir of the first pliant container immediately upon input of gas into the second pliant container from the gas source or after a predetermined duration. In some embodiments, fluid is conveyed from the fluid reservoir of the first pliant container immediately upon input of gas into the gas reservoir of the second pliant container. In these embodiments, methods may include pre-filling the gas reservoir of the second pliant container with an amount of gas sufficient to place the gas reservoir into contact with the fluid reservoir such that any additional gas input results in the application of pressure onto the fluid reservoir by the gas reservoir. For example, the first pliant container may be positioned wholly within the second pliant container and the gas reservoir may be pre-filled with gas such that upon input of any additional gas, pressure from the gas reservoir is applied to the fluid reservoir of the first pliant container.

In other embodiments, fluid is conveyed from the fluid reservoir after a predetermined duration, such as 5 seconds or more after inputting gas into the gas reservoir of the second pliant container, such as after 10 second or more, such as after 15 seconds or more, such as after 30 seconds or more, such as after 60 seconds or more, such as after 120 seconds or more, such as after 240 seconds or more and including 300 seconds or more after inputting gas into the gas reservoir of the second pliant container. For example, where the first pliant container and the second pliant container are not initially in contact with each other, methods may include inputting gas into the gas reservoir for an amount of time sufficient to place the gas reservoir into contact with the fluid reservoir of the first pliant container.

Depending on the amount of pressure applied by the gas reservoir of the second pliant container onto the fluid reservoir of the first pliant container, fluid may be conveyed from the fluid reservoir (e.g., to a sample flow system of a flow cytometer, as discussed below) at a rate that varies, such as at a flow rate of 1 μL/sec or more, such as 2 μL/sec or more, such as 5 μL/sec or more, such as 10 μL/sec or more, such as 25 μL/sec or more, such as 50 μL/sec or more, such as 100 μL/sec or more, such as 250 μL/sec or more, such as 500 μL/sec or more, such as 750 μL/sec or more and including 1000 μL/sec or more. Fluid may be conveyed from the fluid reservoir continuously or in discrete intervals. In some embodiments, fluid is conveyed from the fluid reservoir of the first pliant container continuously. In other embodiments, fluid is conveyed from the fluid reservoir in discrete intervals such as for an interval of 5 seconds or more, such as for 10 seconds or more, such as for 15 seconds or more, such as from 30 seconds or more, such as for 60 seconds or more, such as for 120 seconds or more, such as for 240 seconds or more, such as for 300 seconds or more and including for 600 seconds or more. Where fluid is conveyed from the fluid reservoir in discrete intervals, the time period between each interval may also vary, as desired, being separated independently by a delay of 0.001 millisecond or more, such as 0.01 milliseconds or more, such as 0.1 milliseconds or more, such as 1 millisecond or more, such as 10 milliseconds or more, such as 100 milliseconds or more and including 1000 milliseconds or more. The time period between each discrete interval for conveying fluid from the fluid reservoir may be the same or different.

Fluid may be conveyed from the first pliant container for any desired duration. In some embodiments, fluid is conveyed from the first pliant container by maintaining or increasing gas pressure in the gas reservoir of the second pliant container for 1 minute or longer, such as 5 minutes or longer, such as 15 minutes or longer, such as 30 minutes or longer, such as 60 minutes or longer, such as 6 hours or longer, such as 12 hours or longer, such as 24 hours or longer, such as from 3 days or longer and including for 1 week or longer. In some embodiments, fluid is conveyed from the fluid reservoir until 25% or less of the fluid remains in the fluid reservoir, such as 20% or less, such as 15% or less, such as 10% or less, such as 5% or less and including 1% or less.

In certain embodiments, the subject fluid dispensing systems are coupled to a sample flow system of a flow cytometer. In these embodiments, methods may include coupling the outlet conduit of the first pliant container with an inlet of the sample flow system. The outlet conduit of the first pliant container may be coupled to the sample flow system directly by mating one or more fittings, such as connecting the outlet conduit to the sample flow system with a screw fitting, a Luer slip or a Luer taper fitting, such as a Luer-Lok connection between a male Luer-Lok fitting and a female Luer-Lok fitting. In certain embodiments, methods include connecting a sterile connector to the sample flow system and then coupling the sterile connector to the outlet conduit of the first pliant container. The outlet conduit of the first pliant container and the sample flow system may likewise be coupled to the sterile connector with a screw-thread fitting, a Luer slip or a Luer taper fitting. In certain instances, the sterile connector includes one or more breakable seals (e.g., a single use connector) and to couple the outlet conduit and the sample flow system, seals at each end of the sterile connector are punctured.

In some embodiments, methods include conveying a sterile fluid from the first pliant container to a sample flow system. As discussed above, sterile fluid conveyed from the first pliant container to the sample flow system is free or substantially free from live bacteria or other microorganisms. In practicing the subject methods, the sterile fluid is conveyed (as described in greater detail above) from the first pliant container to the sample flow system by inputting a gas into the second pliant container which applies pressure to the fluid reservoir of the first pliant container and conveying the sterile fluid from the first pliant container reservoir to the sample flow system. To maintain the sterility of the fluid from the first pliant container to the sample flow system, the distal end of the first pliant container outlet conduit is coupled to the sample flow system through a sterile connector. Any convenient sterile fluidic connector may be employed, as described above, such as sterile connector with a screw-thread fitting, a Luer slip, a Luer taper fitting or a sterile connector with one or more breakable seals. To maintain the sterility of the system, the first pliant container is connected to the sample flow system such that the sterile fluid in the first pliant container does not come into contact at any time with the ambient environment or with any surfaces of the subject fluid dispensing system that have come into contact with the ambient environment. As such, before the outlet conduit of the first pliant container is connected to the inlet of the sample flow system, both the outlet conduit of the first pliant container and the inlet of the sample flow system remain sealed. Methods according to certain embodiments of the present disclosure include conveying sheath fluid to a sample flow system of a flow cytometer. Sheath fluids of interest may be any convenient buffered composition and may include one or more salts, including but not limited to potassium phosphate, potassium chloride, sodium phosphate, sodium chloride, preservatives as well as chelating agents, such as disodium ethylenediaminetetraacetic acid (EDTA). For example, methods may include coupling the subject fluid dispensing systems and delivering a sheath fluid to a flow cytometer, such as those described in U.S. Pat. Nos. 3,960,449; 4,347,935; 4,667,830; 5,245,318; 5,464,581; 5,483,469; 5,602,039; 5,643,796; 5,700,692; 6,372,506 and 6,809,804 the disclosure of which are herein incorporated by reference in their entirety.

In some embodiments, methods include disconnecting the first pliant container from the sample flow system and coupling a third pliant container to the sample flow system. Where the first pliant container is coupled to the sample flow system through a sterile connector, the connector may be disconnected from the sample flow system and discarded along with the first pliant container. In embodiments of the present disclosure, no cleaning or washing is conducted or required once the first pliant container is disconnected. In these embodiments, little to no fluid from the first pliant container remains in the sample flow system once the first pliant container is disconnected. In some instances, 1000 μL or less of fluid from the first pliant container remains in the sample flow system, such as 500 μL or less, such as 250 μL or less, such as 100 μL or less, such as 50 μL or less, such as 25 μL or less, such as 10 μL or less, such as 5 μL or less, such as 1 μL or less, such as 0.1 μL or less and including 0.01 μL or less. In certain instances, no (i.e., 0 μL) fluid from the first pliant container remains in the sample flow system after the outlet conduit of the first pliant container is disconnected. In other embodiments where the first pliant container is wholly positioned within the second pliant container, the entire pliant fluid dispensing container structure having the first and second pliant containers may be disconnected and discarded and a second pliant fluid dispensing container structure having a third pliant container that is wholly positioned within a fourth pliant container is reconnected. In these embodiments, the fourth pliant container includes a gas reservoir and a port in gaseous communication with the gas reservoir and is configured to apply pressure to the fluid reservoir of the third pliant container sufficient to convey fluid from the distal end of the third pliant container conduit into the sample flow system of the flow cytometer.

In certain embodiments, methods include maintaining the sterility of the system when replacing a first pliant container with a second pliant container such that fluid conveyed into the sample flow system does not come into contact at any time with the ambient environment or with any surfaces of the fluid dispensing system that have come into contact with the ambient environment.

In some instances, a first pliant container is decoupled from the sample flow system by disconnecting the outlet conduit of the first pliant container from the sterile connector and connecting an outlet conduit of a second pliant container to the sterile connector. In other instances, both the outlet conduit of the first pliant container and the inlet conduit of the sample flow system are disconnected from the sterile connector and the sample flow system and second pliant container are fluidically coupled together by connecting the inlet conduit of the sample flow system and the outlet conduit of the second pliant container through a second sterile connector.

In a first example, methods include:
connecting the distal end of an outlet conduit of a first pliant container to a sterile connector;
connecting an inlet conduit of a sample flow system to the sterile connector;
conveying a first sterile fluid from a first pliant container into the sample flow system;
disconnecting the distal end of the outlet conduit of the first pliant container from the sterile connector;
connecting the distal end of an outlet conduit of a second pliant container to the sterile connector; and
conveying a second sterile fluid from the second pliant container into the sample flow system.

In a second example, methods include:
connecting the distal end of an outlet conduit of a first pliant container to a sterile connector;
connecting an inlet conduit of a sample flow system to the sterile connector;
conveying a first sterile fluid from a first pliant container into the sample flow system;
disconnecting the distal end of the outlet conduit of the first pliant container from the sterile connector;
disconnecting the inlet conduit of the sample flow system from the sterile connector;
connecting the distal end of an outlet conduit of a second pliant container to a second sterile connector;
connecting the inlet conduit of the sample flow system to the second sterile connector; and
conveying a second sterile fluid from the second pliant container into the sample flow system.

In these embodiments, the disconnected first pliant container as well as the sterile connectors may be discarded and no cleaning or washing of any components of the subject fluid dispensing system is conducted or required. By replacing the pliant container and the sterile connector, sterility of the system is maintained without the need to clean or further sterilize any permanent fixtures of the fluid dispensing system. In practicing the subject methods, sterile fluid from one or more different pliant containers is conveyed into a sample flow system (e.g., in a flow cytometer) without any contact by the sterile fluid with the ambient environment or any surfaces of the fluid dispensing system that have come into contact with the ambient environment. In addition, since all of the components of the subject fluid dispensing systems that come into contact with sterile fluid are discarded, there is little to no cross-contamination from any previously conveyed fluid.

In some embodiments, methods including monitoring gas input into the gas reservoir of the second pliant container and fluid flow from the fluid reservoir of the first pliant container. Monitoring includes assessing (either by a human or with the assistance of a computer, if using a computer-automated process initially set up under human direction) gas input and fluid flow to measure the rate and consistency of fluid delivery after one or more intervals of the subject methods. Assessing gas input and fluid flow may include evaluating the flow rate of gas into the gas reservoir, the flow rate of fluid output from the fluid reservoir as well as the ratio of inputted gas to fluid output.

In some embodiments, monitoring includes collecting real-time data, such as by employing one or more gas sensors and fluid sensors to measure the flow rate of gas input and fluid output. In other embodiments, monitoring includes evaluating gas input and fluid output at regular intervals, such as every 1 minute, every 5 minutes, every 10 minutes, every 30 minutes, every 60 minutes or some other interval.

Methods of the present disclosure may also include a step of assessing gas input and fluid output to identify any desired adjustments to the fluid dispensing protocol. In other words, methods include providing feedback based on monitoring gas input and fluid output, where adjustments to the fluid dispensing protocol may vary in terms of goal, where in some instances the desired adjustment are adjustments that ultimately result in improved flow of fluid from the first pliant container, such as to a sample flow system of a flow cytometer. For example, where feedback provided by monitoring gas input and fluid output indicates that fluid flow rate from the first pliant container is too slow, methods may include increasing the gas flow rate, changing the type of gas or changing the second pliant container in the housing. In other instances, where feedback provided by monitoring gas input and fluid output indicates that fluid flow rate from the first pliant container is too fast, methods may include decreasing gas flow rate or changing the type of gas.

### Computer-Controlled Systems

Aspects of the present disclosure may further include computer controlled systems for practicing the subject methods, where the systems further include one or more computers for automation or semi-automation of a system for practicing methods described herein. In certain embodiments, systems include a computer having a computer readable storage medium with a computer program stored thereon, where the computer program when loaded on the computer includes algorithm for inputting a gas from a gas source into a second pliant container to apply an amount of pressure to the reservoir of a first pliant container in a manner sufficient to convey fluid from the reservoir into a sample flow system of a flow cytometer.

In embodiments, the system includes an input module, a processing module and an output module. In some embodiments, the subject systems may include an input module such that parameters or information about the gas source, fluid in the first pliant container and sample flow system may be inputted into the computer. The processing module includes memory having a plurality of instructions for inputting a gas from a gas source into the second pliant container and measuring a flow of fluid from the outlet conduit of the first pliant container. The processing module may also include instructions for feedback monitoring of the fluid dispensing systems described above, where feedback monitoring includes evaluating the flow rate of fluid outputted from the outlet conduit of the first pliant container and the gas pressure is the gas reservoir of the second pliant container and to identify if any desired adjustments are needed. In some embodiments, the processing module contains a plurality of instructions to evaluate fluid flow rate and gas pressure and determine if an increase or decrease in gas input into the gas reservoir of the second pliant container is required, such as to increase or decrease fluid flow from the first pliant container. In certain instances, the processing module contains a plurality of instructions to identify that a decrease or stop in gas output from the gas source is necessary or desired when the positive pressure within the gas reservoir is too high or increasing too quickly. In other instances, the processing module includes a plurality of instructions to identify that an increase in gas output from the gas source is necessary or desired when the positive pressure within the gas reservoir is too low or increasing too slowly.

After the processing module has performed one or more of the steps, an output module may communicate one or more parameters of the subject methods, such as the flow rate of fluid from the outlet conduit of the first pliant container, the gas input rate, as well as pressure being exerted on the first pliant container by the second pliant container.

The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

Systems may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid state storage devices (including magnetic or optical disks or tape or RAM, or any other suitable device, either fixed or portable). The processor may include a general purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (e.g., smartphone).

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g, over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Windows XP, Windows 7, Windows 8, iOS, Sun Solaris, Linux, OS/400, Compaq Tru64 Unix, SGI IRIX, Siemens Reliant Unix, and others.

### Kits

Also provided are kits for practicing one or more embodiments of the above-described methods and/or for use with embodiments of the devices and systems described above. The subject kits may include various components and reagents. Reagents and components of interest may include, according to certain embodiments, a first pliant container, a second pliant container and a sterile connector configured for coupling an outlet conduit of the first pliant container with a flow cytometer sample flow system, sheath fluids, syringes, one or more connectors for connecting the second pliant container with a gas source. For example, kits may include a fluid dispensing structure that includes a first pliant container that is wholly positioned with a second pliant container. Kits may also include pliant containers pre-filled with a fluid, such as sheath fluid, the fluid reservoir. In addition, kits may include one or more fasteners, such as hooks, hook and loop fasteners, latches, notches, grooves, pins, tethers, hinges, and non-permanent adhesives.

In some instances, the kits include a computer readable medium having a computer program stored thereon, wherein the computer program, when loaded into a computer, operates the computer to perform a magnetic separation assay as described herein; and a physical substrate having an address from which to obtain the computer program.

In addition to the above components, the subject kits may further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Yet another means would be a computer readable medium, e.g., CD, DVD, Blu-Ray, flash memory, etc., on which the information has been recorded. Yet another means that may be present is a website address which may be used via the Internet to access the information at a removed site. Any convenient means may be present in the kits.

### Utility

The subject devices, methods, systems and kits find use in a variety of different applications for dispensing a fluid, such as for providing a sheath fluid to a sample flow system of a flow cytometer. In addition, the present disclosure finds use where it is desirable to maintain sterility of a flow system such as where different types sheath fluids may be used and cross-contamination between the different types is undesirable or harmful.

Embodiments of the subject devices, methods, systems and kits find use in providing sterile sheath fluid to a flow system of a flow cytometer, in particular to systems which change often between different types of sheath fluid. Accordingly, the subject devices, methods, systems and kits may be used in protocols which require a substantially sterile environment, such as in the analysis of biological samples in research or medical diagnosis.

For instance, the subject sterile fluid dispensing systems and methods may be used to convey sterile sheath fluid to a flow cytometer for analyzing biological samples used in diagnosis of disease, such as cancer, or diseases caused by microbial infection, including but not limited to the diagnosis of acquired immune deficiency syndrome (AIDS), ascariasis, athletes' foot, bacillary dysentery, botulism, chickenpox, cholera, common cold, dengue fever, diarrhea, diphtheria, filariasis, gonorrhea, herpes, hook worm disease, influenza, kala azar, leprosy, measles, mumps, pinworm disease, plague, pneumonia, poliomyelitis, rabies, ringworm, septic sore throat, sleeping sickness, smallpox, syphilis, tuberculosis, tetanus, typhoid, vaginitis, viral encephalitis, whooping cough. Sterile methods according to embodiments of the disclosure also find use where the sample sizes and volumes are small and highly susceptible to inaccurate diagnosis due to even minor contamination.

The subject fluid dispensing systems and methods also find use in flow cytometry systems used to analyze cells that are sensitive to the properties of the sheath fluid (e.g., pH and conductivity). Since the subject fluid dispensing systems minimize (or altogether eliminates) cross-contamination between different sheath fluids, the subject fluid dispensing systems and methods also find use in high throughput systems used to analyze a large number of different types of biological samples, such as systems for the analysis of 5 different types of biological samples or more, such as 10 different types of biological samples or more and including 25 different types of biological samples or more.

The subject sterile fluid dispensing systems and methods also find use in flow cytometer systems used to sort and process cells for cell therapy. For example, fluid dispensing systems described herein may be used to provide sterile sheath fluid to cell sorting systems to isolate cells for use in allogenic cell therapy, embryonic stem cell therapy, human induce pluripotent stem cell therapy, neural stem cell therapy, mesenchymal stem cell therapy, hematopoietic stem cell transplantation, autologous stem cell therapy, as well as T-cell immunotherapy (e.g., chimeric antigen receptor T-cell therapy, regulatory T-cell therapy), dendritic cell-based cancer immunotherapy among other types of treatment protocols that employ therapeutic cell compositions. In some instances, the subject sterile fluid dispensing systems find use in systems for sorting and isolating therapeutic cells used in the treatment of intestinal conditions such as Crohn's disease, diabetes, neurological and skeletal disorders such as Parkinson's disease, Huntington's disease and Hurler syndrome, vascular diseases such as peripheral artery disease, myocardial infarction, arteriovenous access complications, bone and cartilage regeneration, myocardium regeneration, wound therapy as well as in immunotherapy for treating warts, actinic keratosis, basal cell cancers, vaginal intraepithelial neoplasia, squamous cell cancers, HPV induced tumors, lung cancer, cutaneous lymphomas and superficial malignant melanoma.

The subject systems and methods also provide a way to dispense sheath fluid that can be frequently changed without need for cleaning or disposal of permanent components of a flow system after changing between the different types of fluids. In particular, the subject systems provide for eliminating permanent conduits or connectors used to connect a sample flow system of a flow cytometer to a pressurized tank.

Notwithstanding the appended clauses, the disclosure set forth herein is also defined by the following clauses:

1. A system comprising:

a housing; and

a first pliant container and a second pliant container positioned within the housing, wherein:

the first pliant container comprises:
a fluid reservoir; and
a conduit comprising a proximal end and a distal end, wherein the proximal end is fluidically coupled to the fluid reservoir and the distal end is configured for coupling the conduit to a sample flow system of a flow cytometer; and

the second pliant container comprises:
a gas reservoir; and
a port in gaseous communication with the gas reservoir,

wherein the second pliant container is positioned in the housing with the first pliant container and is configured to apply pressure to the fluid reservoir of the first pliant container sufficient to convey fluid from the distal end of the conduit into the sample flow system of the flow cytometer.

2. The system according to clause 1, wherein the fluid reservoir comprises one or more ports.
3. The system according to clause 2, wherein one or more ports are configured to be irreversibly sealed.
4. The system according to any one of clauses 1 to 3, wherein the conduit is irreversibly affixed to the fluid reservoir.
5. The system according to any one of clauses 1 to 4, wherein the conduit is integrated with the fluid reservoir.
6. The system according to any one of clauses 1 to 5, wherein the fluid reservoir comprises walls having a thickness of 5.0 mm or less.
7. The system according to any one of clauses 1 to 6, wherein the conduit comprises walls having a thickness of 5.0 mm or less.
8. The system according to any one of clauses 1 to 7, wherein the second pliant container is configured to apply a pressure to the first pliant container sufficient to convey fluid from the distal end of the conduit at flow rate of 100 μL/sec or more.
9. The system according to any one of clauses 1 to 8, wherein the second pliant container is configured to apply continuous pressure to the first pliant container.
10. The system according to any one of clauses 1 to 9, wherein the second pliant container is configured to apply pressure to the first pliant container in discrete intervals.
11. The system according to any one of clauses 1 to 10, wherein the second pliant container is configured to apply pressure at a single position on the first pliant container.
12. The system according to any one of clauses 1 to 10, wherein the second pliant container is configured to apply pressure at two or more positions on the first pliant container.
13. The system according to any one of clauses 1 to 12, wherein the first pliant container is positioned at least partially within and stably associated with the second pliant container.
14. The system according to clause 13, wherein the first pliant container is wholly positioned within the second pliant container.
15. The system according to any one of clauses 1 to 14, wherein the distal end of the conduit comprises a sterile connector configured to couple the conduit to the sample flow system of a flow cytometer.
16. The system according to clause 15, wherein the connector is a Luer-lock connector.
17. The system according to clause 15, wherein the connecter is a screw-fit connector.
18. The system according to any one of clauses 1 to 17, wherein the second pliant container further comprises a gas pressure sensor.
19. The system according to clause 18, wherein the gas pressure sensor comprises a control valve.
20. The system according to any one of clauses 1 to 19, further comprising a fastener configured for affixing at least one of the first pliant container and the second pliant container within the housing.
21. The system according to clause 20, wherein the housing comprises a hook configured for hanging one or more of the first pliant container and the second pliant container to a wall within the housing.
22. The system according to clause 21, wherein the first pliant container and second pliant container comprise a hole configured for hanging the first pliant container and second pliant container onto the hook.
23. The system according to clause 20, wherein the fastener comprises a hook and loop fastener.
24. The system according to clause 20, wherein the fastener comprises an adhesive.
25. A fluid dispensing container structure comprising:

a first pliant container positioned at least partially within and stably associated with a second pliant container, wherein the first pliant container comprises:
a fluid reservoir; and
a conduit comprising a proximal end and a distal end, wherein the proximal end is fluidically coupled to the fluid reservoir and the distal end is configured for coupling to a sample flow system of a flow cytometer; and

the second pliant container comprises:
a gas reservoir; and
a port in gaseous communication with the gas reservoir.
   26. The container structure according to clause 25, wherein the fluid reservoir comprises one or more ports.
   27. The container structure according to clause 26, wherein one or more ports are configured to be irreversibly sealed.
   28. The container structure according to any one of clauses 25 to 27, wherein the conduit is irreversibly affixed to the fluid reservoir.
   29. The container structure according to any one of clauses 25 to 27, wherein the conduit is integrated with the fluid reservoir.
   30. The container structure according to any one of clauses 25 to 29, wherein the fluid reservoir comprises walls having a thickness of 5.0 mm or less.
   31. The container structure according to any one of clauses 25 to 30, wherein the conduit comprises walls having a thickness of 5.0 mm or less.
   32. The container structure according to any one of clauses 25 to 31, wherein the gaseous reservoir of the second pliant container is smaller by volume than the fluidic reservoir of the first pliant container.
   33. The container structure according to any one of clauses 25 to 32, wherein the gaseous reservoir of the second pliant container is larger by volume than the fluidic reservoir of the first pliant container.
   34. The container structure according to any one of clauses 25 to 33, wherein the first pliant container is wholly positioned within the second pliant container.
   35. The container structure according to any one of clauses 25 to 34, wherein the distal end of the conduit comprises a sterile connector configured to couple the conduit to the sample flow system of a flow cytometer.
   36. The container structure according to clause 35, wherein the connector is a Luer-lock connector.
   37. The container structure according to clause 35, wherein the connecter is a screw-fit connector.
   38. The container structure according to any one of clauses 25 to 37, further comprising a fastener configured for affixing at least one of the first pliant container and the second pliant container to an interior wall of a housing.
   39. The container structure according to clause 38, wherein the housing comprises a hook configured for hanging one or more of the first pliant container and the second pliant container to the interior wall.
   40. The container structure according to clause 39, wherein the first pliant container and second pliant container comprise a hole for hanging the first pliant container and second pliant container onto the hook.
   41. The container structure according to clause 38, wherein the fastener comprises a hook and loop fastener.
   42. The container structure according to clause 38, wherein the fastener comprises an adhesive.
   43. A method for dispensing fluid, the method comprising:

providing a flow cytometer comprising a sample flow system in fluid communication with a first pliant container, wherein the first pliant container comprises a reservoir comprising an amount of a fluid;

inputting a gas into a second pliant container to apply an amount of pressure to the reservoir of the first pliant container in a manner sufficient to convey fluid from the reservoir into the sample flow system of the flow cytometer through a conduit coupled to the first pliant container.

44. The method according to clause 43, wherein the fluid conveyed into the flow cytometer sample flow system is sheath fluid.
45. The method according to any one of clauses 43 to 44, wherein pressure is applied to the first pliant container continuously.
46. The method according to any one of clauses 43 to 44, wherein pressure is applied to the first pliant container in discrete intervals.
47. The method according to any one of clauses 43 to 44, wherein a constant pressure is applied to the first pliant container.
48. The method according to any one of clauses 43 to 47, wherein pressure is applied to the first pliant container in a manner sufficient to convey fluid from the distal end of the conduit at flow rate of 100 μL/sec or more.
49. The method according to any one of clauses 43 to 48, wherein pressure is applied at a single position on the first pliant container.
50. The method according to any one of clauses 43 to 48, wherein pressure is applied at two or more positions on the first pliant container.
51. The method according to any one of clauses 43 to 50, wherein the first pliant container is positioned at least partially within and stably associated with the second pliant container.
52. The method according to any one of clauses 43 to 50, wherein the first pliant container is wholly positioned within the second pliant container.
53. The method according to any one of clauses 43 to 52, further comprising coupling the distal end of the conduit to the flow cytometer sample flow system with a sterile connector.
54. The method according to clause 53, wherein the connector is a Luer-lock connector.
55. The method according to clause 53, wherein the connecter is a screw-fit connector.
56. The method according to clause 53, wherein the conduit of the first pliant container is sealed until the distal end is coupled to the sterile connector.
57. The method according to clause 56, wherein the sample flow system of the flow cytometer is sealed until the first pliant container is coupled to the sterile connector.
58. The method according to clause 53, further comprising disconnecting the distal end of the conduit from the flow cytometer sample flow system.
59. The method according to clause 58, wherein disconnecting the distal end of the conduit from the flow cytometer sample flow system comprises disposing of the connector.
60. The method according to clause 59, further comprising coupling a third pliant container to the flow cytometer sample flow system after disconnecting the first pliant container.
61. The method according to clause 60, wherein the sample flow system of the flow cytometer becomes sealed when the first pliant container is disconnected from the sterile connector.
62. The method according to clause 60, wherein no fluid from the first pliant container remains in the sample flow system after disconnecting the first pliant container.
63. The method according to clause 60, wherein the third pliant container is coupled to the flow cytometer sample flow system in the absence of any cleaning or washing.
64. The method according to any one of clauses 43 to 63, further comprising affixing at least one of the first pliant container and the second pliant container to an interior wall of a housing of the sample flow system.
65. The method according to clause 64, wherein affixing comprises hanging one or more of the first pliant container and the second pliant container to a hook on the wall.
66. The method according to clause 65, wherein the first pliant container and the second pliant container comprise a hole configured for hanging the first pliant container and second pliant container onto the hook.
67. The method according to clause 64, wherein affixing comprises coupling one or more of the first pliant container and the second pliant container to the wall with a hook and loop fastener.
68. The method according to clause 64, wherein affixing comprising coupling one or more of the first pliant container and the second pliant container to the wall with an adhesive.
69. A kit comprising:

a first pliant container;

a second pliant container; and

a sterile connector configured for coupling a conduit of the first pliant container to a flow cytometer sample flow system.

70. The kit according to clause 69, wherein the first pliant container comprises a reservoir comprising an amount of a fluid.
71. The kit according to clause 70, wherein the fluid is sheath fluid.
72. A kit comprising two or more container structures, each container structure comprising a first pliant container positioned at least partially within and stably associated with a second pliant container.
73. A kit comprising:

a first pliant container;

a second pliant container; and

a fastener configured to affix one or more of the first pliant container and the second pliant container within a housing.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A system comprising:
a housing; and
a first pliant container and a second pliant container positioned within the housing, wherein:
the first pliant container comprises:
a fluid reservoir; and
a conduit comprising a proximal end and a distal end, wherein the proximal end is fluidically coupled to the fluid reservoir and the distal end is configured for coupling the conduit to a sample flow system of a flow cytometer; and
the second pliant container comprises:
a gas reservoir; and
a port in gaseous communication with the gas reservoir,
wherein the second pliant container is positioned in the housing with the first pliant container and is configured to apply pressure to the fluid reservoir of the first pliant container sufficient to convey fluid from the distal end of the conduit into the sample flow system of the flow cytometer.

2. The system according to claim 1, wherein the fluid reservoir comprises walls having a thickness of 5.0 mm or less and the conduit comprises walls having a thickness of 5.0 mm or less.

3. The system according to claim 1, wherein the second pliant container is configured to apply a pressure to the first pliant container sufficient to convey fluid from the distal end of the conduit at flow rate of 100 μL/sec or more.

4. The system according to claim 1, wherein the first pliant container is positioned at least partially within and stably associated with the second pliant container.

5. The system according to claim 1, wherein the distal end of the conduit comprises a sterile connector configured to couple the conduit to the sample flow system of a flow cytometer.

6. The system according to claim 1, further comprising a fastener configured for affixing at least one of the first pliant container and the second pliant container within the housing.

7. A fluid dispensing container structure comprising:
a first pliant container positioned at least partially within and stably associated with a second pliant container, wherein the first pliant container comprises:
a fluid reservoir; and
a conduit comprising a proximal end and a distal end, wherein the proximal end is fluidically coupled to the fluid reservoir and the distal end is configured for coupling to a sample flow system of a flow cytometer; and
the second pliant container comprises:
a gas reservoir; and
a port in gaseous communication with the gas reservoir.

8. The container structure according to claim 7, wherein the first pliant container is wholly positioned within the second pliant container.

9. The container structure according to claim 7, wherein the distal end of the conduit comprises a sterile connector configured to couple the conduit to the sample flow system of a flow cytometer.

10. A method for dispensing fluid, the method comprising:
providing a flow cytometer comprising a sample flow system in fluid communication with a first pliant container, wherein the first pliant container comprises a reservoir comprising an amount of a fluid;
inputting a gas into a second pliant container to apply an amount of pressure to the reservoir of the first pliant container in a manner sufficient to convey fluid from the reservoir into the sample flow system of the flow cytometer through a conduit coupled to the first pliant container.

11. The method according to claim 10, wherein the first pliant container is positioned at least partially within and stably associated with the second pliant container and pressure is applied at two or more positions on the first pliant container.

12. The method according to claim 10, further comprising coupling the distal end of the conduit to the flow cytometer sample flow system with a sterile connector,
wherein the conduit of the first pliant container is sealed until the distal end is coupled to the sterile connector.

13. The method according to claim 10, further comprising: disconnecting the distal end of the conduit from the flow cytometer sample flow system;
disposing of the connector; and
coupling a third pliant container to the flow cytometer sample flow system after disconnecting the first pliant container,
wherein the sample flow system of the flow cytometer becomes sealed when the first pliant container is disconnected from the sterile connector.

14. The method according to claim 13, wherein no fluid from the first pliant container remains in the sample flow system after disconnecting the first pliant container.

15. A kit comprising:
a first pliant container;
a second pliant container; and
a sterile connector configured for coupling a conduit of the first pliant container to a flow cytometer sample flow system, wherein the first pliant container comprises a reservoir comprising an amount of a fluid.
